(19) United States
(12) Patent Application Publication
(10) Pub. No.: US 2022/0306101 A1
(43) Pub. Date: Sep. 29, 2022

(54) AUTOMATIC CONTROL DEVICE FOR MOTORCYCLE

(71) Applicant: HONDA MOTOR CO., LTD., Tokyo (JP)

(72) Inventors: Masaki NAKAGAWARA, TOKYO (JP); Kyosuke INADA, TOKYO (JP); Atsushi OGAHARA, TOKYO (JP)

(21) Appl. No.: 17/666,976

(22) Filed: Feb. 8, 2022

(30) Foreign Application Priority Data
Mar. 24, 2021 (JP) 2021-050328

(51) Int. Cl. B60W 30/14; B60W 10/06; B60W 10/184; B62J 45/20

(52) U.S. Cl. CPC B60W 30/143; B60W 10/06; B60W 10/184; B62J 45/20; B60W 2510/184; B60W 2710/06; B60W 2710/184; B60W 2555/20

(57) ABSTRACT

An automatic control device for a motorcycle including a control device that automatically controls an automatic cruise control system and a brake system including a front wheel brake and a rear wheel brake includes a brake temperature detection unit that detects a brake temperature. The control device varies operation states of the front wheel brake and the rear wheel brake according to the brake temperature during automatic cruise control. At a time of deceleration in a case where the brake temperature during the automatic cruise control is low, the control device raises the brake temperature by reducing an engine brake of a power unit of a vehicle and increasing operation frequencies of the front wheel brake and the rear wheel brake.

### TECHNICAL FIELD

The present invention relates to an automatic control device for a motorcycle, and more particularly to an automatic control device for a motorcycle that enables automatic control based on various types of sensor information.

### BACKGROUND ART

Conventionally, there has been known a saddle-type vehicle that enables automatic cruise control of operating an engine or a brake system of the vehicle to travel at a constant speed or to travel following a preceding vehicle by automatic control based on various types of sensor information.

Patent Literature 1 discloses braking force control of a motorcycle in which a front-rear distribution of a braking force during traveling by automatic cruise control is automatically adjusted on the basis of a slip degree of front and rear wheels.

### CITATION LIST

### Patent Literature

### Patent Literature 1: JP 2020-15366 A

### SUMMARY OF INVENTION

### Technical Problem

Incidentally, the friction coefficients of a brake pad and a brake disc tend to decrease when a brake temperature decreases, and there is a possibility that a desired braking force cannot be obtained at an initial stage when the brake system is automatically controlled in a state where the brake temperature is low.

An object of the present invention is to solve the above-described problems of the related art and to provide an automatic control device for a motorcycle that enables automatic cruise control in consideration of a brake temperature.

### Solution to Problem

In order to achieve the above object, in accordance with a first feature of the present invention, an automatic control device for a motorcycle including a control device (70) that automatically controls an automatic cruise control system (75) that enables traveling at a constant speed or traveling following a preceding vehicle in accordance with various types of information and a brake system (76) that includes a front wheel brake (BF) and a rear wheel brake (BR) includes a brake temperature detection unit (71) that detects a brake temperature. The control device (70) varies operation states of the front wheel brake (BF) and the rear wheel brake (BR) according to the brake temperature during automatic cruise control.

In accordance with a second feature, at a time of deceleration in a case where the brake temperature during the automatic cruise control is lower than a predetermined value, the control device (70) increases the brake temperature by reducing an engine brake of a power unit (P) of a vehicle and increasing operation frequencies of the front wheel brake (BF) and the rear wheel brake (BR).

In accordance with a third feature, the brake temperature detection unit (71) estimates and detects the brake temperature on the basis of output information of an outside air temperature sensor (73) and an ignition switch (74).

### Advantageous Effects of Invention

According to the first feature, the automatic control device for a motorcycle including the control device (70) that automatically controls the automatic cruise control system (75) that enables traveling at a constant speed or traveling following a preceding vehicle in accordance with various types of information and the brake system (76) that includes the front wheel brake (BF) and the rear wheel brake (BR) includes the brake temperature detection unit (71) that detects a brake temperature. The control device (70) varies operation states of the front wheel brake (BF) and the rear wheel brake (BR) according to the brake temperature during automatic cruise control. Thus, for example, in a case where the brake temperature is low, at the time of deceleration during the automatic cruise control, the operation frequency of the front and rear brakes is controlled to increase, so as to raise the brake temperature and increase the friction coefficient of the brake pad, whereby a desired brake braking force can be obtained.

According to the second feature, at a time of deceleration in a case where the brake temperature during the automatic cruise control is lower than a predetermined value, the control device (70) increases the brake temperature by reducing an engine brake of the power unit (P) of the vehicle and increasing operation frequencies of the front wheel brake (BF) and the rear wheel brake (BR). Thus, the brake temperature can be raised without using any special device.

According to the third feature, the brake temperature detection unit (71) estimates and detects the brake temperature on the basis of output information of the outside air temperature sensor (73) and the ignition switch (74). Thus, the brake temperature can be estimated and detected without using any special device.

### BRIEF DESCRIPTION OF DRAWINGS

FIG. 1 is a right side view of a motorcycle to which an automatic control device according to an embodiment of the present invention is applied.

FIG. 2 is a block diagram illustrating a configuration of the automatic control device according to this embodiment.

FIG. 3 is a flowchart illustrating a procedure of brake temperature rise control according to this embodiment.

### DESCRIPTION OF EMBODIMENTS

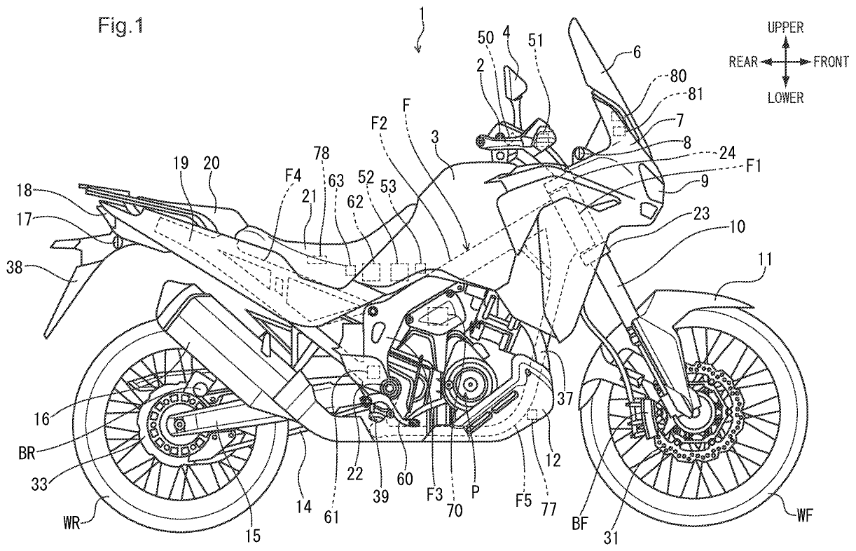

Hereinafter, a preferred embodiment of the present invention will be described in detail with reference to the drawings. FIG. 1 is a right side view of a motorcycle 1 to which an automatic control device according to an embodiment of the present invention is applied. The motorcycle 1 is a saddle-type vehicle that transmits a driving force of a power unit P to a rear wheel WR via a drive chain 14. A steering stem (not illustrated) is pivotally supported in a swingable manner by a head pipe F1 positioned at the front end of a vehicle body frame F. A bottom bridge 23 and a top bridge 24 supporting a pair of right and left front forks 10 are fixed to the lower and upper sides of the steering stem.

A steering handle 2 supporting a pair of right and left rearview mirrors 4 is attached to the upper portion of the top bridge 24. A brake lever 50 as a front wheel brake operator is attached to the right side of the steering handle 2. A front wheel brake caliper BF as a front wheel brake which applies a braking force to a front wheel brake disc 31 rotating synchronously with a front wheel WF and a front fender 11 are attached to the front fork 10.

A pair of right and left main frames F2 extending obliquely rearward and downward and an underframe F5 extending downward and supporting the lower side of the power unit P are attached to the rear portion of the head pipe F1. A pivot frame F3 having a pivot 22 pivotally supporting a swing arm 15 in a swingable manner is connected to the rear end of the main frame F2, and the rear end portion of the underframe F5 is connected to the lower end portion of the pivot frame F3. A pair of right and left foot placement steps 39 on which a driver places his/her feet are attached to the pivot frame F3.

The driving force of the power unit P surrounded and supported by the main frame F2 and the underframe F5 is transmitted to the rear wheel WR via the drive chain 14. An under guard 12 is attached to a front bottom portion of the power unit P. The combustion gas of the power unit P is sent to a muffler 16 on the rear side of a vehicle body via an exhaust pipe 37 passing through the inside of the under guard 12.

The rear wheel WR is pivotally supported in a rotatable manner on a rear end portion of the swing arm 15 pivotally supported by the pivot 22. The swing arm 15 supports a rear wheel brake caliper BR as a rear wheel brake that applies a braking force to the rear wheel brake disc 33 rotating synchronously with the rear wheel WR. A brake pedal 60 as a rear wheel brake operator operated by the right foot of the driver is pivotally supported in a swingable manner on the pivot frame F3 on the right side in a vehicle width direction.

A front cowl 7 that supports a headlight 9, a windproof screen 6, and a pair of right and left front flasher lamps 8 is arranged on the vehicle-body front side of the head pipe F1. A fuel tank 3 is arranged on the vehicle-body rear side of the front cowl 7 and above the main frame F2. A rear frame F4 that supports a front seat 21 on which the driver sits and a rear seat 20 on which a passenger sits is fixed to the rear portion of the pivot frame F3. The right and left sides of the rear frame F4 in the vehicle width direction are covered with a rear cowl 19, and a rear fender 38 that supports a tail lamp device 18 and a pair of right and left rear flasher lamps 17 is attached to the rear end portion of the rear cowl 19.

A control device 70 that controls a fuel injection device, an ignition device, a brake system, and the like is arranged above the power unit P. A front wheel-side brake actuator (hereinafter, may be simply referred to as an actuator) 52 that generates the brake fluid pressure of a front wheel brake BF and a rear wheel-side brake actuator 62 that generates the brake fluid pressure of a rear wheel brake BR are arranged above the vehicle body frame F. A front wheel brake fluid pressure sensor 53 that detects the brake fluid pressure of the front wheel brake BF and a rear wheel brake fluid pressure sensor 63 that detects the brake fluid pressure of the rear wheel brake BR are arranged in the vicinity of the actuators 52 and 62, respectively. A front wheel brake operation force sensor 51 that detects the operation force input to the brake lever 50 is arranged in the vicinity of the brake lever 50, and a rear wheel brake operation force sensor 61 that detects the operation force input to the brake pedal 60 is arranged in the vicinity of the brake pedal 60.

A seating sensor 76 that detects the seated state of the driver is arranged inside the front seat 21. Further, a road surface sensor 77 that detects whether the road surface is wet is arranged inside the under guard 12.

A front camera 80 and a front radar 81 used for the automatic control of an automatic cruise control system and a brake system are arranged on the rear side of the windproof screen 6. In the brake system according to this embodiment, normally, the actuators 52 and 62 generate brake fluid pressures corresponding to the operation forces of the brake operators 50 and 60, and when an automatic control condition such as approach of an obstacle detected by the front camera 80 and the front radar 81 is satisfied or a deceleration condition based on deceleration of a preceding vehicle during automatic cruise control or the like is satisfied, the control device 70 automatically generates an optimum brake fluid pressure even when the brake operators 50 and 60 are not operated. At the time of the automatic control of the brake system, a front-rear distribution such as front 7:rear 3 and front 6:rear 4 is also automatically set according to a vehicle speed, a vehicle body posture, a road surface condition, and the like.

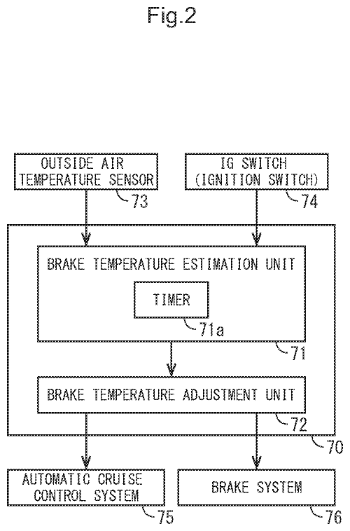

FIG. 2 is a block diagram illustrating a configuration of the automatic control device according to this embodiment. The control device 70 includes a brake temperature estimation unit 71 and a brake temperature adjustment unit 72 as brake temperature detection units. The brake temperature estimation unit 71 receives information from an outside air temperature sensor 73 and an IG switch (ignition switch) 74. The brake temperature estimation unit 71 includes a timer 71a, and is configured to measure a time from when the IG switch 74 is turned off and to estimate and detect a brake temperature in accordance with the information of the outside air temperature sensor 73.

In a case where the brake temperature detected by the brake temperature estimation unit 71 is lower than a predetermined value, the brake temperature adjustment unit 72 automatically controls the automatic cruise control system 75 and the brake system 76 to raise the brake temperature. Incidentally, in the embodiment of the present invention, an example has been described in which the automatic cruise control system 75 and the brake system 76 are separate bodies. However, the automatic cruise control system and the brake system may be configured integrally with the control device 70.

Specifically, in a case where the brake temperature is lower than the predetermined value, at the time of deceleration during the automatic cruise control, the operation frequency of the front and rear brakes is controlled to increase, so as to raise the brake temperature and increase the friction coefficient of the brake pad, whereby a desired brake braking force can be obtained from an initial stage.

More specifically, at the time of deceleration in a case where the brake temperature during the automatic cruise control is low, the control device 70 is configured to reduce the engine brake of the power unit P of the vehicle by cooperating with a throttle by wire or a transmission and increase the operation frequency of the front wheel brake BF and the rear wheel brake BR, so as to raise the brake temperature. Accordingly, it is possible to obtain the desired braking force from the initial stage particularly at the time of sudden deceleration during the automatic cruise control.

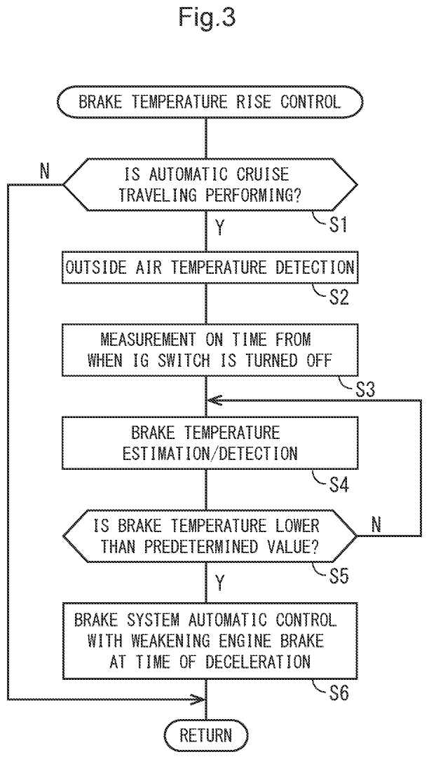

FIG. 3 is a flowchart illustrating a procedure of brake temperature rise control according to this embodiment. In step S1, it is determined whether the automatic cruise control system is performing automatic cruise traveling. When an affirmative determination is made in step S1, the process proceeds to step S2, and the outside air temperature is detected by the outside air temperature sensor 73. When a negative determination is made in step S1, the series of control is ended as it is.

In subsequent step S3, a time from when the IG switch is turned off is measured by the timer 71a, and the brake temperature is estimated and detected in step S4. In the estimation detection of the brake temperature, data such as a temperature transition graph determined in advance by an experiment or the like can be used. The time from when the IG switch is turned off can be recorded in a nonvolatile memory or the like, and for example, it is easy to estimate and detect the brake temperature in a case where the vehicle runs on an automatic cruise after a long break in a service area of an expressway. Incidentally, when the stop time of the vehicle is equal to or longer than a predetermined time, the brake temperature may be estimated from the outside air temperature and the time during which the ignition switch is turned off, and after the start of traveling, the brake temperature may be estimated from the integrated value of the deceleration amount.

In step S5, it is determined whether the brake temperature is lower than the predetermined value (for example, 5 degrees). When an affirmative determination is made in step S5, the process proceeds to step S6, and control for weakening the engine brake at the time of deceleration and increasing the operation frequency of the brake system is executed, and the series of control is ended. Incidentally, when a negative determination is made in step S5, the process returns to step S4.

As described above, the automatic control device for a motorcycle according to this embodiment includes the brake temperature detection unit 71 that detects the brake temperature. The control device 70 varies the operation states of the front wheel brake BF and the rear wheel brake BR according to the brake temperature during the automatic cruise control. Thus, in a case where the brake temperature is low, at the time of deceleration during the automatic cruise control, the operation frequency of the front and rear brakes is controlled to increase, so as to raise the brake temperature and increase the friction coefficient of the brake pad, whereby a desired brake braking force can be obtained.

At the time of deceleration in a case where the brake temperature during the automatic cruise control is low, the control device 70 is configured to reduce the engine brake of the power unit P of the vehicle and increase the operation frequency of the front wheel brake BF and the rear wheel brake BR, so as to raise the brake temperature. Thus, the brake temperature can be increased without using any special device.

The brake temperature detection unit 71 estimates and detects the brake temperature on the basis of the output information of the outside air temperature sensor 73 and the ignition switch 74, and thus the brake temperature can be estimated and detected without using any special device.

Incidentally, the form of the motorcycle, the configuration of the brake system, the manner of applying the engine brake during the automatic cruise control, the method of increasing the frequency of brake operation accompanying the weakening of the engine brake, the setting of the predetermined value of the brake temperature, and the like are not limited to the above-described embodiment, and various changes can be made. For example, the brake temperature may be detected by a sensor that directly measures the brake temperature. Further, instead of measuring the time from when the ignition switch is turned off, the time from when the wheel stops may be measured. Further, in a case where the brake temperature is high, the engine brake may be configured to be strengthened to reduce the operation frequency of the brake system. The automatic control device according to the present invention is not limited to be applied to a motorcycle, and can be applied to a saddled-type tricycle or quadricycle, or the like. Further, the braking distribution and the operation timing of the front and rear brakes may be changed depending on a road gradient and a loading state.

### REFERENCE SIGNS LIST

1 motorcycle (saddle-type vehicle)
70 control device
71 brake temperature estimation unit
71a timer
72 brake temperature adjustment unit
73 outside air temperature sensor
74 IG switch (ignition switch)
75 automatic cruise control system
76 brake system
80 front camera
81 front radar
BF front wheel brake
BR rear wheel brake

1. An automatic control device for a motorcycle including a control device that automatically controls an automatic cruise control system that enables traveling at a constant speed or traveling following a preceding vehicle in accordance with various types of information and a brake system that includes a front wheel brake and a rear wheel brake, the automatic control device for a motorcycle comprising:
a brake temperature detection unit that detects a brake temperature, wherein
the control device varies operation states of the front wheel brake and the rear wheel brake according to the brake temperature during automatic cruise control.

2. The automatic control device for a motorcycle according to claim 1, wherein
at a time of deceleration in a case where the brake temperature during the automatic cruise control is lower than a predetermined value, the control device raises the brake temperature by reducing an engine brake of a power unit of a vehicle and increasing operation frequencies of the front wheel brake and the rear wheel brake.

3. The automatic control device for a motorcycle according to claim 1, wherein
the brake temperature detection unit estimates and detects the brake temperature on a basis of output information of an outside air temperature sensor and an ignition switch.
